(19) United States
(12) Patent Application Publication
(10) Pub. No.: US 2026/0170796 A1
(43) Pub. Date: Jun. 18, 2026

(54) EFFECTIVE MOTION RECOGNITION METHOD AND SYSTEM IN EMBEDDED/EDGE ENVIRONMENT

(71) Applicant: Korea Electronics Technology Institute, Seongnam-si (KR)

(72) Inventors: Kyoung Won MIN, Seongnam-si (KR); Ganzorig GANKHUYAG, Seoul (KR); Jae Woong YOO, Seongnam-si (KR); Yong Hyeon CHO, Seoul (KR)

(73) Assignee: Korea Electronics Technology Institute, Seongnam-si (KR)

(21) Appl. No.: 19/004,878

(22) Filed: Dec. 30, 2024

(30) Foreign Application Priority Data
Dec. 13, 2024 (KR) 10-2024-0185946

(51) Int. Cl. G06V 10/75; G06T 7/246; G06V 10/62; G06V 10/77; G06V 40/20

(52) U.S. Cl. CPC G06V 10/751; G06T 7/248; G06V 10/62; G06V 10/7715; G06T 2207/10016; G06T 2207/20081; G06T 2207/30196; G06V 40/28

(57) ABSTRACT

There is provided am effective motion recognition method and system in an embedded/edge environment. A motion recognition method according to an embodiment may sample time-series image data that is obtained by photographing a target object, and time-series key data that is extracted from the time-series image data, may reshape the sampled time-series image data to a type of image data of a spatial domain and may extract spatial features, may reshape the image data a type of time-series image data, may unify the reshaped time-series image data and the sampled time-series key point data, may extract temporal features, and may recognize motions of the target object.

### CROSS-REFERENCE TO RELATED APPLICATION(S) AND CLAIM OF PRIORITY

This application is based on and claims priority under 35 U.S.C. § 119 to Korean Patent Application No. 10-2024-0185946, filed on Dec. 13, 2024, in the Korean Intellectual Property Office, the disclosure of which is herein incorporated by reference in its entirety.

### BACKGROUND

### Field

The disclosure relates to deep learning-based motion recognition, and more particularly, to a method and a system for efficiently recognizing continuous motions, such as hand signals of a police officer, in an embedded system (edge device).

### Description of Related Art

### 1. Need for AI Motion Recognition Models Operable in Embedded Systems

Research and development based on artificial intelligence (AI) have been ongoing in various research fields, such as 2D/3D obstacle sensing-based cameras or light detection and ranging (LIDAR), road lane detection, free space division, traffic signal detection, or the like to commercialize autonomous vehicles.

Hand signal recognition is a technology that recognizes hand signals that police officers make to control vehicles in longitudinal/transverse directions to avoid or escape urgent situations such as errors of road signal lights, traffic accidents, traffic jam, etc., and it is important to recognize hand signals rapidly and exactly and to provide the result of recognition to a vehicle control device.

Most of the related-art image-based motion recognition methods focuses on the accuracy of sorting and has a heavy AI network structure with various strategies and many parameters to acquire high result accuracy. However, such structures are difficult to operate in an embedded system (edge device) environment that has limited performance and limited power supply like autonomous vehicles or various road side equipment.

In addition, the related-art methods do not consider redundancy of input images inputted to an AI network, and hence, even when an actual motion is not performed, redundant image frames that do not require computation may be inputted, so that effective computation may not be performed and motion recognition performance may be degraded.

### 2. Motion Recognition

A continuous motion recognition technology is a technology that recognizes motions by collecting continuous motion data by using various sensors and interpreting data, and the core function thereof is appropriately extracting feature information of motions to be interpreted from input signals of a sensor such as a camera or the like.

As shown in FIG. 1, a skeleton is constituted by using key points as feature information, and then, motions are cognized based on changes in the shape of the skeleton. However, when an overlap, occlusion occurs between key points according to motions, it is difficult to separate, identify positions of key points and thus there is a problem that accuracy of recognition is degraded.

To solve this problem, a SlowFast method using features of an image has appeared, which is illustrated in FIG. 2. As shown in FIG. 2, the SlowFast method includes a slow pathway operating at a low frame rate speed to detect spatial features, and a fast pathway operating at a high frame rate speed to detect changes in temporal features. The fast pathway occupies only 20% of the total computation, and is designed to detect relatively fewer channels and fewer spatial features. The two pathways are laterally connected to be used for motion recognition.

However, the fast pathway is highly likely to fail to recognize motions that are not well expressed in an image since it uses only image data, and the SlowFast method is constituted with two types of pathways, and thus has a problem that it is not appropriate for implementing in an embedded system with limited resources and power due to high complexity and lots of computations.

### 3. Input Frames During Motion Recognition

In a typical motion recognition algorithm, the number of input frames may be fixed, and the fixed value thereof may be set before training and inference. This varies according to an algorithm and a model primarily used.

### Setting of Number of Frames

A motion recognition model typically receives the fixed number of frames. For example, it is common to learn by using a predetermined number of frames such as 8, 16, 32, 60, 120 frames to recognize a specific motion. The fixed number of frames may be set differently according to a structure of an AI model and a structure of training data. For example, a total suspended matter (TSM) algorithm may receive 8 continuous frames as input to perform motion recognition, and ActionVLAD, VideoGraph may receive 64 continuous frames as input to perform motion recognition.

There is a method that selectively receives and processes only some frames which are important in processing total video sequences. For example, the above-described SlowFast network may extract spatial features from 8 frames that are sampled at a low frame rate in input data sequences in the slot pathway, and may extract temporal features from n continuous frames of a higher frame rate in the fast pathway.

Meanwhile, motions that a motion recognition system recognizes may not be always performed and may be only performed in a specific situation to transmit information effectively. Therefore, motions may not be performed often. FIGS. 3 to 5 show input of 30 continuous frames to perform motion recognition. Continuous motions may be inputted as shown in FIG. 3, but there may be continuous sections where motions are not performed as shown in the latter part of FIG. 4 or the former part of FIG. 5. In this situation, performance degradation such as errors in sorting motions may occur in the motion recognition system, and there may be a problem that computation resources of an embedded system are not effectively used.

### SUMMARY

The disclosure has been developed in order to solve the above-described problems, and an object of the disclosure is to provide a method and a system for recognizing motions by using all of spatial features and temporal features regarding image data, and features of key point data, as a solution for enabling motion recognition to be performed in a small low-power edge device having relatively low computing power, and enhancing motion recognition performance.

Another object of the disclosure is to provide a method and a system for recognizing motions by processing with new frames only when there is a change as a result of comparing similarity between frames, as a solution for enhancing real-time recognition performance by reducing unnecessary frame processing in recognizing continuous motions, and maximizing efficiency of system resources.

To achieve the above-described objects, a motion recognition method may include: a step of sampling time-series image data that is obtained by photographing a target object, and time-series key data that is extracted from the time-series image data; a first reshaping step of reshaping the sampled time-series image data to a type of image data of a spatial domain; a first extraction step of extracting spatial features from the reshaped image data; a second reshaping step of reshaping the image data from which the spatial features are extracted to a type of time-series image data; a step of unifying the reshaped time-series image data and the sampled time-series key point data; a second extraction step of extracting temporal features from the unified time-series data; and a step of recognizing motions of the target object based on the extracted temporal features.

The step of sampling may include: a step of calculating a similarity between two frames by comparing each input frame of the time-series image data with a previous frame; and a step of, when it is determined that the two frames are similar as a result of calculating the similarity, discarding the input frame and the key point data.

The step of sampling may include: a step of, when it is determined that the two frames are not similar as a result of calculating the similarity, storing the input frame and the key point data in an input buffer; and a step of, when the number of frames stored in the input buffer equals to a pre-set frame threshold value, providing the frames stored in the input buffer and the key point data to the first reshaping step and the second reshaping step, respectively.

The step of calculating the similarity may include: a step of calculating the similarity based on appearance data on the two frames; a step of calculating the similarity based on key points on the two frames; and a step of calculating a final similarity by unifying the calculated similarities.

The first reshaping step may include reshaping the time-series image data to the type of image data of the spatial domain according to the following equation:

$${I}_{f}^{( B \times Seq , C , W , H )} = reshape ( {I}^{( B , Seq , C , W , H )} )$$

where I_{f}^{(B×Seq,C,W,H)} is image data of a spatial domain, I^{(B,Seq,C,W,H)} is time-series image data, B is a batch size, Seq is sequence data, C is a channel, W is a width, and H is a height.

The second reshaping step may include reshaping the image data from which the spatial features are extracted to the type of time-series image data according to the following equation:

$${I}_{seq}^{( B \times Seq , dim 0 )} = reshape ( {X}^{( B \times Seq , dim 0 )} )$$

where I_{seq}^{(B,Seq,dim0)} is time-series image data, X^{(B×Seq,dim0)} is image data from which spatial features are extracted, and dim0 is a dimension of image data from which spatial features are extracted.

According to an embodiment, the motion recognition method may further include a step of adding an index and position information of each key point to the time-series key point data. The step of adding may include: generating an index of each key point through input embedding; and generating position information of each key point through positional encoding.

The step of unifying may include unifying the time-series image data and the time-series key point data by concatenating.

According to another embodiment of the disclosure, a motion recognition system may include: a sampling unit configured to sample time-series image data that is obtained by photographing a target object, and time-series key point data that is extracted from the time-series image data; a first extraction unit configured to reshape the sampled time-series image data to a type of image data of a spatial domain, and to extract spatial features from the reshaped image data; a second reshaping unit configured to reshape the image data from which the spatial features are extracted to a type of time-series image data; a unification unit configured to unify the reshaped time-series image data and the sampled time-series key point data; a second extraction unit configured to extract temporal features from the unified time-series data; and a recognition unit configured to recognize motions of the target object based on the extracted temporal features.

According to still another embodiment of the disclosure, a motion recognition method may include: a step of sampling time-series image data that is obtained by photographing a target object, and time-series key point data that is extracted from the time-series image data; a first extraction step of extracting spatial features from the sampled time-series image data; a step of unifying the time-series image data from which the spatial features are extracted, and the sampled time-series key point data; a second extraction step of extracting temporal features from the unified time-series data; and a step of recognizing motions of the target object based on the extracted temporal features.

As described above, according to embodiments of the disclosure, motions may be recognized by using all of spatial features and temporal features regarding image data, and features of key point data, so that motions can be more stably recognized even when there are a plurality of objects at the same time and an overlap, occlusion frequently occur.

According to embodiments of the disclosure, spatial features and temporal features regarding image data are embedded in sequence, so that lots of computations are not required and motion recognition can be performed in a small low-power edge device having relatively low computing power.

In addition, according to embodiments of the disclosure, a similarity between frames is calculated, and only when there is a change, new frames are processed, so that unnecessary frames may be removed when continuous motions such as hand signals are recognized, and only important frames may be selectively processed, and accordingly, more accurate motion recognition is possible.

In addition, according to embodiments of the disclosure, by dynamically adjusting the number of input frames to be used for motion recognition, unnecessary data processing may be reduced and system resources may be saved, and real-time processing performance may be greatly enhanced with limited hardware resources.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view illustrating an example of key point-based motion recognition;

FIG. 2 is a view illustrating a SlowFast method;

FIG. 3 is a view illustrating an example of frame input;

FIG. 4 is a view illustrating an example of frame input;

FIG. 5 is a view illustrating an example of frame input;

FIG. 6 is a view illustrating a motion recognition system according to an embodiment of the disclosure;

FIG. 7 is a view illustrating a detailed structure of an image feature extraction unit;

FIG. 8 is a view illustrating a detailed structure of a key point encoding unit;

FIG. 9 is a view illustrating a lightweight transformer encoder;

FIG. 10 is a view illustrating a motion recognition method according to another embodiment of the disclosure; and

FIG. 11 is a view illustrating a similarity-based image data sampling method.

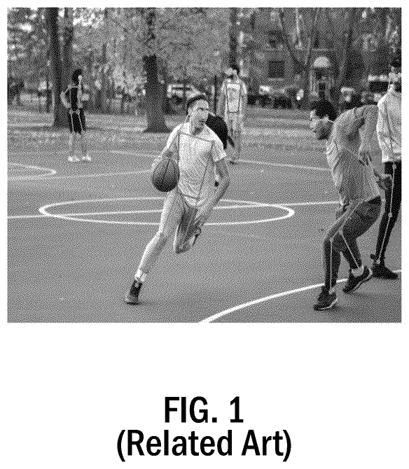

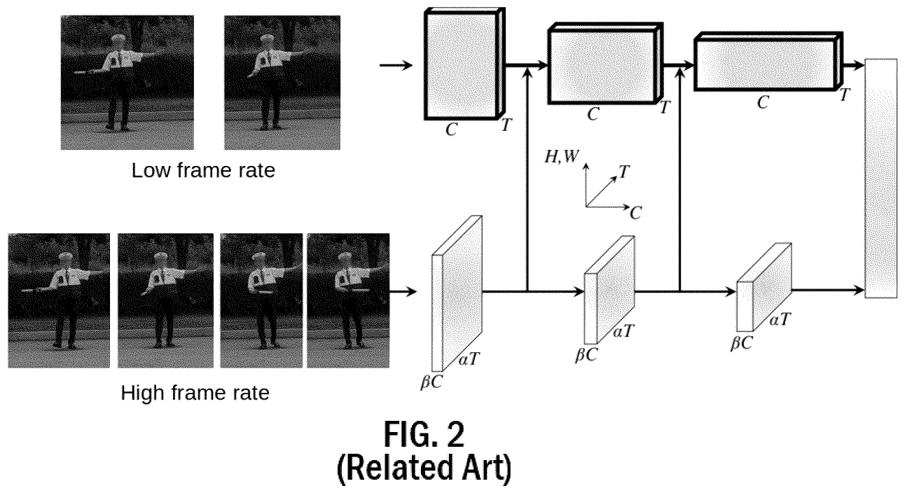

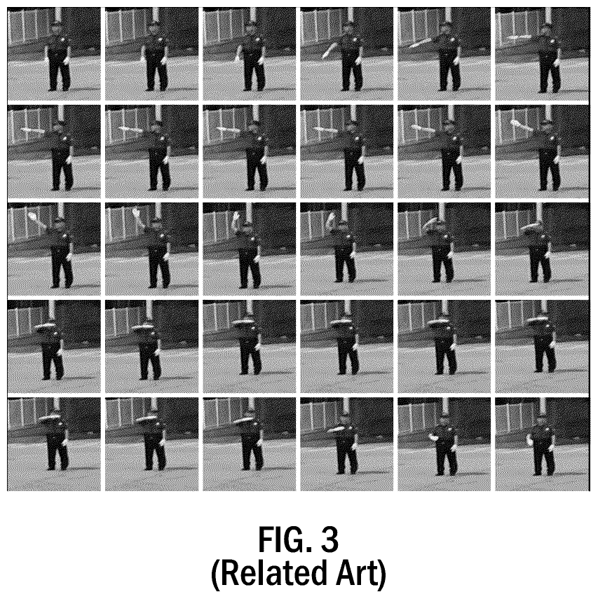

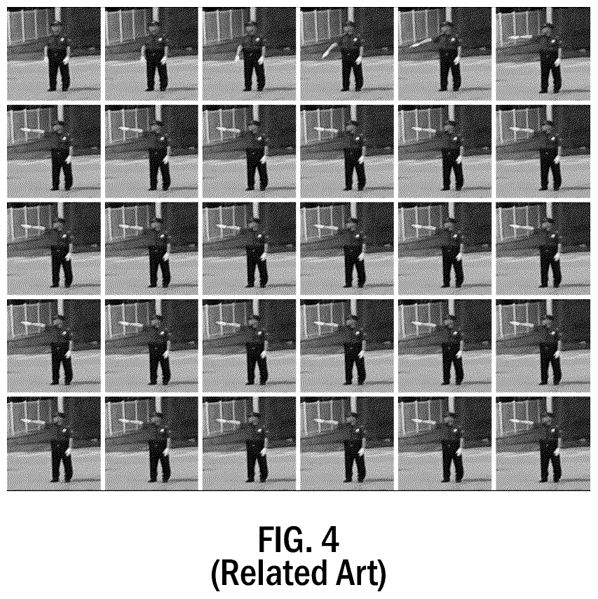

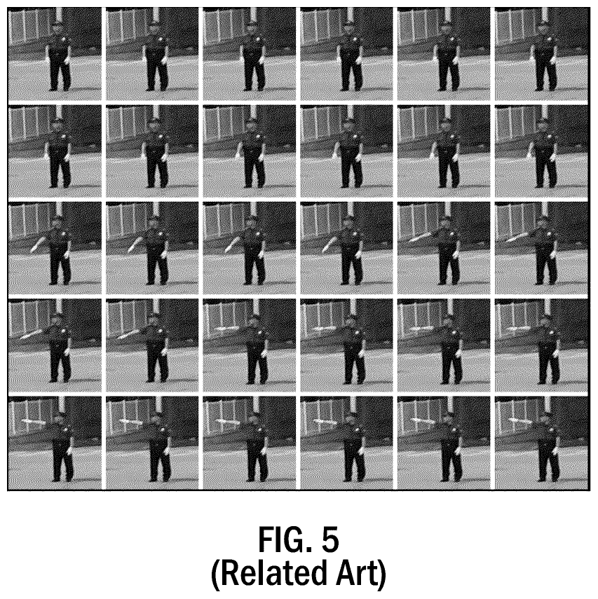

### DETAILED DESCRIPTION

Hereinafter, the disclosure will be described in more detail with reference to the accompanying drawings.

Embodiments of the disclosure provide an effective motion recognition method and system in an embedded/edge environment.

The disclosure relates to a technology for recognizing motions that are frequently occluded by other objects, such as hand signals of a police officer, by using all of spatial features and temporal features regarding image data, and features of key point data, and for recognizing motions by few computations by embedding spatial features and temporal features for image data in sequence.

Compared to related-art motion recognition methods which use the fixed number of frames as input and process data in a uniform sampling method, the method according to an embodiment of the disclosure may enhance efficiency of a system by reducing unnecessary data processing by analyzing similarity between inputted frames, and may enhance the accuracy of motion recognition in real time.

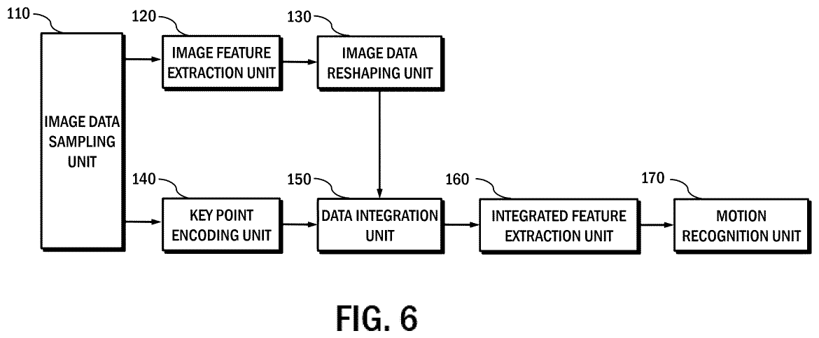

FIG. 6 is a view illustrating a configuration of a motion recognition system according to an embodiment of the disclosure. As shown in FIG. 6, the motion recognition system according to an embodiment may include an image data sampling unit 110, an image feature extraction unit 120, an image data reshaping unit 130, a key point encoding unit 140, a data unification unit 150, a unified feature extraction unit 160, and a motion recognition unit 170.

The image data sampling unit 110 may receive time-series image data that is obtained by cutting only a bounding box through which a target object is detected from the time-series image data (image sequences) obtained by photographing the target object, and key point data that is obtained by extracting key points therefrom, and may extract only image data and key point data necessary for motion recognition. Specifically, the image data sampling unit 110 may sample with new frames and key point data only when there is a difference between frames by comparing similarity between input frames. That is, when a current frame is similar to a previous frame, the image data sampling unit 110 may discard the current frame and key point data thereof, and, only when there is the difference, may buffer the frames and may transmit the same to the image feature extraction unit 120 and the key point encoding unit 140, respectively.

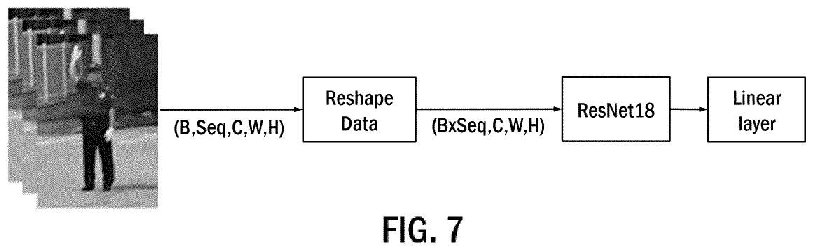

The image feature extraction unit 120 may receive the time-series image data which is sampled and outputted by the image data sampling unit 110, and may extract spatial features. FIG. 7 illustrates a detailed structure of the image feature extraction unit 120.

As shown in FIG. 7, the image feature extraction unit 120 may reshape the time-series image data to a type of image data of a spatial domain, first, in order to extract spatial features from the time-series image data. An equation for reshaping may be expressed by the following Equation 1:

$${I}_{f}^{( B \times Seq , C , W , H )} = reshape ( {I}^{( B , Seq , C , W , H )} ) \qquad Equation 1$$

where I_{f}^{(B×Seq,C,W,H)} is image data of a spatial domain, I^{(B,Seq,C,W,H)} is time-series image data, B is a batch size, Seq is sequence data, C is a channel, W is a width, and H is a height.

This process is a process for reshaping a type of image data of a temporal domain to a type of image data of a spatial domain, and also is a process of transforming 5D data (batch size, sequence, channel, width, height) into 4D data (B×Seq, Channel, W, H).

Next, the image feature extraction unit 120 extracts features in the spatial domain, that is, spatial features, from the reshaped image data (spatial domain feature extraction). The spatial domain feature extraction may be performed by using a lightweight deep learning network such as Resnet 18, EfficientNetB0, Mobilenet, and MobilenetV2.

Referring back to FIG. 6, the image data reshaping unit 130 reshapes the image data of the spatial domain from which features are extracted by the image feature extraction unit 110 to a type of time-series image data which is image data of a temporal domain. An equation for reshaping may be expressed by the following Equation 2:

$${I}_{seq}^{( B , Seq , dim 0 )} = reshape ( {X}^{( B \times Seq , dim 0 )} ) \qquad Equation 2$$

where I_{seq}^{(B,Seq,dim0)} is time-series image data, X^{(B×Seq,dim0)} is image data of a spatial domain from which features are extracted, and dim0 is a dimension of image data of a spatial domain from which features are extracted.

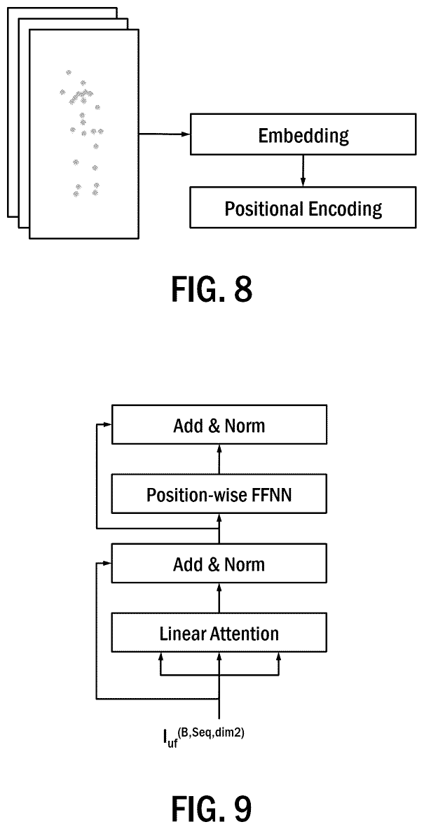

Meanwhile, the key point encoding unit 140 may receive time-series key point data that is extracted from the time-series image data which is sampled and outputted by the image data sampling unit 110, and may encode the time-series key point data. FIG. 8 illustrates a detailed structure of the key point encoding unit 140.

As shown in FIG. 8, the key point encoding unit 140 may add an index and position information of each key point to the time-series key point data. To achieve this, the index of each key point may be generated through input embedding, and the position information of each key point may be generated through positional encoding.

The key point data should be processed by a transformer encoder which will be described below. However, since the transformer encoder does not process data in sequence, the index and the position information are added to the key point data.

The encoded time-series key point data may be expressed by I_{key}^{(B,Seq,dim1)}. Here, dim1 indicates a dimension of encoded time-series key point data.

Referring back to FIG. 6, the data unification unit 150 unifies the time-series image data from which spatial features are extracted, outputted from the image data reshaping unit 130, and the time-series key point data which is encoded by the key point encoding unit 130. Unification is performed by concatenating, and may be expressed by the following Equation 3:

$${I}_{uf}^{( B , Seq , dim 2 )} = concate ( {I}_{seq}^{( B , Seq , dim 0 )} , {I}_{key}^{( B , Seq , dim1 )} ) \qquad Equation 3$$

where I_{uf}^{(B,Seq,dim2)} is unified time-series data, I_{seq}^{(B,Seq,dim0)} is time-series image data from which spatial features are extracted, I_{key}^{(B,Seq,dim1)} is encoded time-series key point data, B is a batch size, Seq is sequence data, and dim2 is a dimension of unified time-series data.

The unified feature extraction unit 160 extracts temporal features from the time-series data unified by the data unification unit 150. Temporal domain feature extraction may be performed by using a lightweight transformer encoder. The lightweight transformer encoder is illustrated in FIG. 9.

Referring back to FIG. 6, the motion recognition unit 170 recognizes motions of the target object, based on the temporal features extracted by the unified feature extraction unit 160. The motion recognition unit 170 may be implemented by a multi-layer perceptron (MLP).

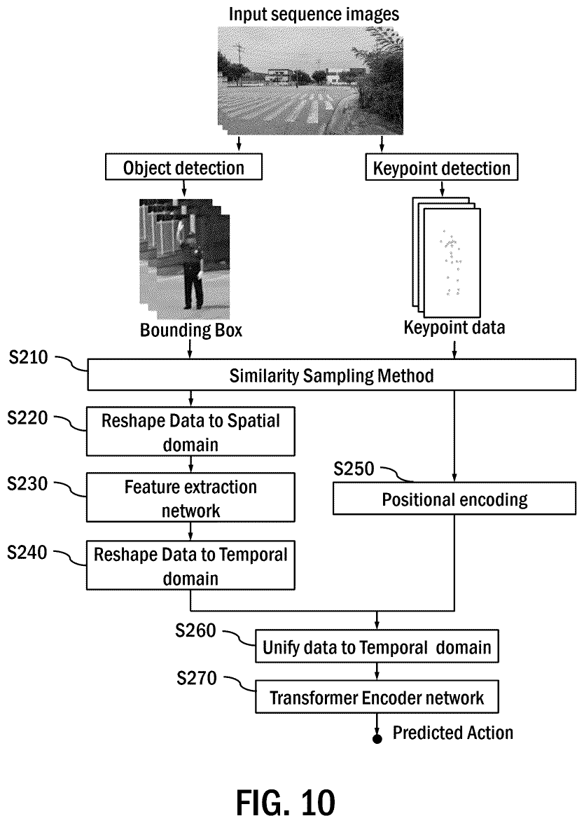

FIG. 10 is a flowchart illustrating a motion recognition method according to another embodiment of the disclosure.

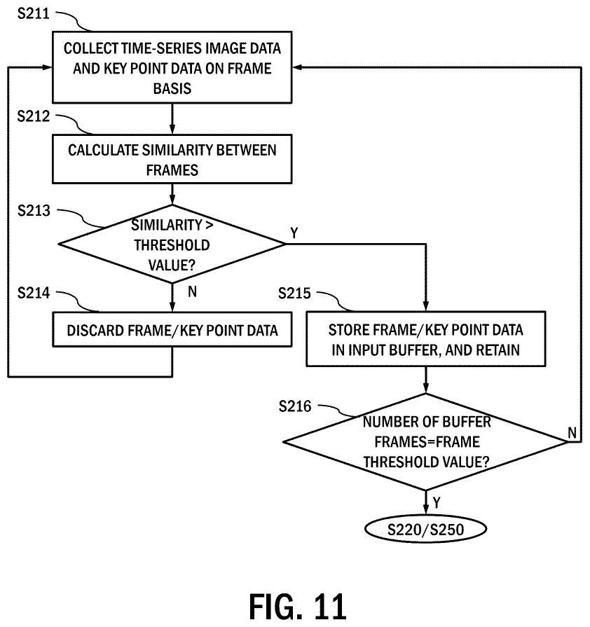

As shown in FIG. 10, to recognize motions, the image data sampling unit 110 may receive time-series image data that is obtained by cutting only a bounding box through which a target object is detected from the time-series image data obtained by photographing the target data, and may sample only image data to be used for motion recognition and key point data extracted therefrom (S210). Step S210 will be described in detail below with reference to FIG. 11.

The image feature extraction unit 120 may reshape the time-series image data which is sampled at step S210 to a type of image data of a spatial domain (S220).

The image feature extraction unit 120 may extract spatial features from the image data reshaped at step S220 (S230), and the image data reshaping unit 130 may reshape the image data from which the spatial features are extracted at step S230 to a type of time-series image data which is image data of a temporal domain (S240).

Meanwhile, the key point encoding unit 140 may encode the time-series key point data that is sampled at step S210, and may add an index and position information of each key point (S250).

The data unification unit 150 may unify the time-series image data from which the spatial features are extracted and which is reshaped at step S240, and the time-series key point data which is encoded at step S250 (S260).

Thereafter, the unified feature extraction unit 160 may extract temporal feature from the time-series data unified at step S260, and the motion recognition unit 170 may recognize motions of the target object based on the extracted temporal features (S270).

Hereinafter, step S210 will be described in detail with reference to FIG. 11. FIG. 11 is a detailed flowchart of a similarity-based time-series image data sampling method.

The image data sampling unit 110 may collect time-series image data that is obtained by cutting only a detected target object, and time-series key point data extracted therefrom on a frame basis (S211). The image data sampling unit 110 may calculate a similarity between two frames by comparing each input frame of the time-series image data collected at step S211 with a previous frame (S212). The similarity may be calculated by the following process.

### 1) Calculating Similarity Based on Appearance Data

The method of calculating similarity based on appearance data is a method of calculating an absolute difference between two frames by comparing each input frame collected and a previous frame. The absolute difference may be a sum of absolute values converted from differences between pixel values. The absolute difference may be calculated by Equation 4 presented below:

$${D}_{appearance} ( {f}_{current} , {f}_{previous} ) = {\sum }_{i , j} \vert {f}_{current} ( i , j ) - {f}_{previous} ( i , j ) \vert \qquad Equation 4$$

where f_{current}(i,j) and fₚᵣₑᵥᵢₒᵤₛ(i,j) refer to pixel values of a current frame and a previous frame, respectively.

### 2) Calculating Similarity Based on Key Point

Key point-based similarity calculation refers to a method of extracting a target object, for example, key points of a police officer (primary joint points), from each frame, and calculating a similarity by comparing changes in positions of the corresponding key points. This method may be effective for recognizing hand gestures of a police officer or body motions. By calculating a difference in key point coordinates between the current frame and the previous frame, a similarity may be calculated from a change in motions between the two frames. The change in key point coordinates may be calculated by Equation 5 presented below:

$${D}_{keypoint} ( {f}_{current} , {f}_{previous} ) = {\sum }_{k = 1}^{N} \sqrt{{( {x}_{k}^{current} - {x}_{k}^{previous} )}^{2}} \qquad Equation 5$$

where xₖ is coordinates of each key point k, and N is the total number of extracted key points.

### 3) Calculating Final Similarity

A final similarity may be calculated by averaging the similarity calculated based on appearance data and the similarity calculated based on key point data, which may be expressed by the following equation 6:

$$D ( {f}_{current} , {f}_{previous} ) = \frac{{D}_{keypoint} ( {f}_{current} , {f}_{previous} ) + {D}_{keypoint} ( {f}_{current} , {f}_{previous} )}{2} \qquad Equation 6$$

When the final similarity is calculated, the image data sampling unit 110 may compare the calculated final similarity with a pre-set threshold value (S213), and, when the final similarity is less than or equal to the threshold value, that is, when it is determined that the two frames are similar (S213-Y), the image data sampling unit 110 may discard the input frame and the key point data thereof (S214), and may return to step S211. Similarities calculated at step S212 described above refer to difference between the two frames, so that the final similarity is lower as the two frames are more similar.

On the other hand, when the final similarity is less than the threshold value, that is, when it is determined that the two frames are not similar (S213-N), the input frame and the key point data thereof may be stored in an input buffer and retained (S215).

Processing input frames according to the similarity according to steps S213 to S215 may be expressed by the following equation:

$$if D ( {f}_{current} , {f}_{previous} ) > Threshold , then keep {f}_{current} , else discard {f}_{current}$$

As a result of the above-described process, only important frames that are determined to have a change from the previous frame, and key point data thereof are stored in the input buffer. Thereafter, the number of frames stored in the input buffer is compared with a pre-set frame threshold value. When the number of stored frames equals to the frame threshold value (S216-Y), steps S220 and S250 may proceed to start the motion recognition procedure. On the other hand, when the number of stored frames is less than the frame threshold value (S216-N), step S211 may resume.

Up to now, an effective motion recognition method and system in an embedded system has been described in detail with reference to preferred embodiments.

In the above-described embodiments, motions that are frequently occluded by other objects, such as hand signals of a police officer, can be recognized by using all of spatial features and temporal features regarding image data, and features of key point data, and motions can be recognized by few computations by embedding spatial features and temporal features for image data in sequence.

A method of extracting frames from video sequences at regular intervals and using the frames may constantly maintain the amount of inputted data, but has a problem that unnecessary frames are included. For example, even when a police officer performing hand gestures does not move, an image with the fixed number of frames may be inputted, and hence, the same information may be repeatedly inputted, causing waste of system resources and degrading motion recognition performance. To solve this problem, embodiments of the disclosure propose a method of discarding a frame when a current frame and a previous frame are similar, and maintaining only when there is a difference.

The similarity-based sampling method proposed in embodiments of the disclosure is designed to be operate to be easily added to or removed from a police officer motion recognition model. That is, the proposed sampling method may be easily integrated into or separated from the motion recognition model, and is flexibly applicable to various motion recognition systems.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A motion recognition method comprising:
a step of sampling time-series image data that is obtained by photographing a target object, and time-series key data that is extracted from the time-series image data;
a first reshaping step of reshaping the sampled time-series image data to a type of image data of a spatial domain;
a first extraction step of extracting spatial features from the reshaped image data;
a second reshaping step of reshaping the image data from which the spatial features are extracted to a type of time-series image data;
a step of unifying the reshaped time-series image data and the sampled time-series key point data;
a second extraction step of extracting temporal features from the unified time-series data; and
a step of recognizing motions of the target object based on the extracted temporal features.

2. The motion recognition method of claim 1, wherein the step of sampling comprises:
a step of calculating a similarity between two frames by comparing each input frame of the time-series image data with a previous frame; and
a step of, when it is determined that the two frames are similar as a result of calculating the similarity, discarding the input frame and the key point data.

3. The motion recognition method of claim 2, wherein the step of sampling comprises:
a step of, when it is determined that the two frames are not similar as a result of calculating the similarity, storing the input frame and the key point data in an input buffer; and
a step of, when the number of frames stored in the input buffer equals to a pre-set frame threshold value, providing the frames stored in the input buffer and the key point data to the first reshaping step and the second reshaping step, respectively.

4. The motion recognition method of claim 2, wherein the step of calculating the similarity comprises:
a step of calculating the similarity based on appearance data on the two frames;
a step of calculating the similarity based on key points on the two frames; and
a step of calculating a final similarity by unifying the calculated similarities.

5. The motion recognition method of claim 1, wherein the first reshaping step comprises reshaping the time-series image data to the type of image data of the spatial domain according to the following equation:
$${I}_{f}^{( B \times Seq , C , W , H )} = reshape ( {I}^{( B , Seq , C , W , H )} )$$
where I_{f}^{(B×Seq,C,W,H)} is image data of a spatial domain, I^{(B,Seq,C,W,H)} is time-series image data, B is a batch size, Seq is sequence data, C is a channel, W is a width, and H is a height.

6. The motion recognition method of claim 5, wherein the second reshaping step comprises reshaping the image data from which the spatial features are extracted to the type of time-series image data according to the following equation:
$${I}_{seq}^{( B , Seq , dim 0 )} = reshape ( {X}^{( B \times Seq , dim 0 )} )$$
where I_{Seq}^{(B,Seq,dim0)} is time-series image data, X^{(B×Seq,dim0)} is image data from which spatial features are extracted, and dim0 is a dimension of image data from which spatial features are extracted.

7. The motion recognition method of claim 1, further comprising a step of adding an index and position information of each key point to the time-series key point data.

8. The motion recognition method of claim 7, wherein the step of adding comprises:
generating an index of each key point through input embedding; and
generating position information of each key point through positional encoding.

9. The motion recognition method of claim 1, wherein the step of unifying comprises unifying the time-series image data and the time-series key point data by concatenating.

10. A motion recognition system comprising:
a sampling unit configured to sample time-series image data that is obtained by photographing a target object, and time-series key point data that is extracted from the time-series image data;
a first extraction unit configured to reshape the sampled time-series image data to a type of image data of a spatial domain, and to extract spatial features from the reshaped image data;
a second reshaping unit configured to reshape the image data from which the spatial features are extracted to a type of time-series image data;
a unification unit configured to unify the reshaped time-series image data and the sampled time-series key point data;
a second extraction unit configured to extract temporal features from the unified time-series data; and
a recognition unit configured to recognize motions of the target object based on the extracted temporal features.

11. A motion recognition method comprising:
a step of sampling time-series image data that is obtained by photographing a target object, and time-series key point data that is extracted from the time-series image data;
a first extraction step of extracting spatial features from the sampled time-series image data;
a step of unifying the time-series image data from which the spatial features are extracted, and the sampled time-series key point data;
a second extraction step of extracting temporal features from the unified time-series data; and
a step of recognizing motions of the target object based on the extracted temporal features.
